(19) United States
(12) Patent Application Publication
(10) Pub. No.: US 2020/0240380 A1
(43) Pub. Date: Jul. 30, 2020

(54) Fuel Injection Valve

(71) Applicant: Hitachi Automotive Systems, Ltd., Hitachinaka-shi, Ibaraki (JP)

(72) Inventors: Takaki ITAYA, Hitachinaka (JP); Noriyuki MAEKAWA, Hitachinaka (JP); Takao MIYAKE, Hitachinaka (JP)

(21) Appl. No.: 16/756,422

(22) PCT Filed: Nov. 15, 2018
(86) PCT No.: PCT/JP2018/042227

§ 371 Date: Apr. 15, 2020

(30) Foreign Application Priority Data
Dec. 12, 2017 (JP) 2017-238014

(51) Int. Cl. F02M 61/18

(52) U.S. Cl. CPC F02M 61/1813

(57) ABSTRACT

Dispersibility of fuel in a combustion chamber is improved while adhesion of the fuel to a structure in the combustion chamber is suppressed, and a combustion state of the fuel in the combustion chamber is improved, thereby improving fuel efficiency and suppressing incomplete combustion. Therefore, in a fuel injection valve provided with the plurality of fuel injection holes surrounded by a seat portion, the fuel injection holes have different penetrations. At least one high-pressure fuel injection hole having the longest penetration and low-pressure fuel injection holes excluding the fuel injection hole are included. Among the inter-inlet distances of the adjacent fuel injection holes, an inter-inlet distance between the fuel injection hole and the fuel injection holes adjacent thereto is widest.

### TECHNICAL FIELD

The present invention relates to a fuel injection valve.

### BACKGROUND ART

A fuel injection valve installed in an internal combustion engine injects fuel directly into a combustion chamber. Some fuel injection valves are provided with a plurality of fuel injection holes, but the one described in PTL 1 is an example which aims to suppress the variation in atomization by making the fuel injection length of each fuel injection hole uniform.

Adhesion of fuel to the wall of the combustion chamber, the ignition plug, the piston, and the like may adversely affect the fuel efficiency and combustion state. The spread of the sprayed fuel in the combustion chamber differs depending on the change in the fuel injection amount according to the load of the internal combustion engine and the temperature and pressure of the combustion chamber. For example, when the pressure in the combustion chamber is lower than the atmospheric pressure, the boiling point of fuel is lowered and the sprayed fuel is easily spread, and the penetration (fuel injection length) defined by the longest reaching distance of the sprayed fuel from the fuel injection valve in the combustion chamber is hard to set. In addition, when the temperature of fuel or the combustion chamber is high, the vaporization of fuel is promoted, a penetration force of the sprayed fuel is reduced, and it becomes difficult for the fuel to reach the entire combustion chamber.

On the other hand, PTL 2 discloses a fuel injection valve that includes an annular array of first injection holes in which the opening area of the outlet is large with respect to the opening area of the inlet and an annular array of second injection holes in which the opening area of the outlet is small with respect to the opening area of the inlet. According to this fuel injection valve, by switching between a state in which only the first injection hole is opened and a state in which the first injection hole and the second injection hole are opened in accordance with the operating conditions of the engine, the penetration can be changed depending on the scene.

### CITATION LIST

### Patent Literatures

PTL 1: JP 2013-68125 A

PTL 2: JP 2009-62925 A

### SUMMARY OF INVENTION

### Technical Problem

In the fuel injection valve of PTL 2, although the penetration can be changed depending on the scene, there is no difference in the penetration between the first injection holes or between the second injection holes. Therefore, fuel is similarly injected from each injection hole belonging to the same annular array. However, from the viewpoint of dispersing the fuel in the combustion chamber as uniformly as possible while suppressing the adhesion of the fuel to the structure in the combustion chamber, an appropriate penetration of each fuel injection hole differs for each injection direction.

An object of the invention is to provide a fuel injection valve which improves dispersibility of fuel in a combustion chamber while suppressing adhesion of the fuel to a structure in the combustion chamber, and improves a combustion state of the fuel in the combustion chamber, thereby improving fuel efficiency and suppressing incomplete combustion.

### Solution to Problem

In order to achieve the above object, the invention provides a fuel injection valve having a plurality of fuel injection holes, in which an inter-inlet distance between adjacent fuel injection holes is made different to adjust penetration of the sprayed fuel for each fuel injection hole.

### Advantageous Effects of Invention

According to this invention, dispersibility of fuel in a combustion chamber is improved while adhesion of the fuel to a structure in the combustion chamber is suppressed, and a combustion state of the fuel in the combustion chamber is improved, thereby improving fuel efficiency and suppressing incomplete combustion.

### BRIEF DESCRIPTION OF DRAWINGS

FIG. 1 is a cross-sectional view illustrating a schematic configuration of an example of a fuel injection valve according to a first embodiment of the invention.

FIG. 2 is a view of a main part of an example of a nozzle tip provided in the fuel injection valve of FIG. 1, viewed from a valve body side.

FIG. 3 is a cross-sectional view taken along line III-III in FIG. 2.

FIG. 4 is a view of a main part of another example of the nozzle tip provided in the fuel injection valve of FIG. 1, viewed from the valve body side.

FIG. 5 is a schematic view of an internal combustion engine equipped with the fuel injection valve of FIG. 1.

FIG. 6 is a schematic view of the internal combustion engine equipped with the fuel injection valve of FIG. 4.

FIG. 7 is a view of a main part of a nozzle tip provided in a fuel injection valve according to a second embodiment of the invention, viewed from a valve body side.

FIG. 8 is a cross-sectional view taken along line VIII-VIII in FIG. 7.

FIG. 9 is a view of a main part of a nozzle tip provided in a fuel injection valve according to a third embodiment of the invention, viewed from a valve body side.

FIG. 10 is a cross-sectional view taken along line X-X in FIG. 7.

FIG. 11 is a view of a main part of a nozzle tip provided in a fuel injection valve according to a fourth embodiment of the invention, viewed from a valve body side.

FIG. 12 is a cross-sectional view taken along line XII-XII in FIG. 11.

### DESCRIPTION OF EMBODIMENTS

Embodiments of the invention will be described below with reference to the drawings.

### Embodiments

Hereinafter, embodiments of the invention will be described using the drawings.

### First Embodiment

Fuel Injection Valve

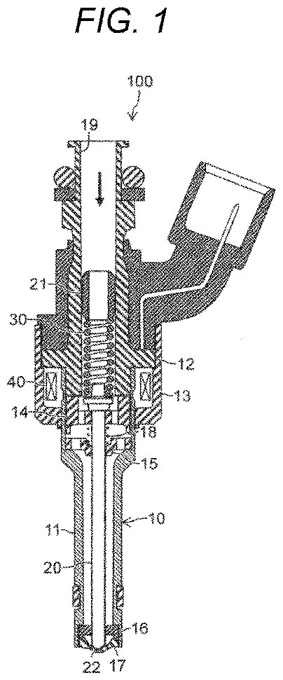

FIG. 1 is a cross-sectional view illustrating a schematic configuration of an example of a fuel injection valve according to a first embodiment of the invention. A fuel injection valve 100 illustrated in FIG. 1 includes a body 10, a valve body 20, a spring 30, a solenoid 40, and the like.

The body 10 is a valve body of the fuel injection valve 100, and includes a nozzle holder 11, a core 12, a housing 13, guides 15 and 16, a nozzle tip 17, and the like. The nozzle holder 11 is a cylindrical member, and includes an anchor 14, the guides 15 and 16, and the nozzle tip 17, and is housed and mounted on the tip side (the lower side in the drawing) of the core 12. The guide 15 is mounted on the base side of the nozzle holder 11 (upper side in the drawing). The anchor 14 is arranged on the core 12 side with respect to the guide 15, and is inserted into the nozzle holder 11 with a spring 18 interposed between the anchor 14 and the guide 15. The guide 16 is housed and mounted on the tip side (the lower side in the drawing) of the nozzle holder 11. The nozzle tip 17 is a fuel injection unit having a plurality of fuel injection holes (described later), and is mounted on the tip of the nozzle holder 11. The solenoid 40 is provided on the outer periphery of the core 12, and the outer periphery of the core 12 and the solenoid 40 is surrounded by the housing 13. A fuel passage 19 is provided in the core 12. Fuel from a high-pressure fuel pump (not illustrated) flows through the fuel passage 19, and is further injected from the nozzle tip 17 through a hollow portion of the nozzle holder 11.

The valve body 20 is housed in the nozzle holder 11, and the valve body 20 is slidably held by the guides 15 and 16. The anchor 14 is mounted on the base side (the core 12 side) of the valve body 20. The spring 30 is housed in the fuel passage 19 of the core 12, and is interposed between the valve body 20 and an adjuster pin 21. The adjuster pin 21 is mounted on the core 12 so that the position of the adjuster pin 21 can be adjusted in the direction of expansion and contraction of the spring 30 inside the fuel passage 19. The base end (the upper end in the drawing) of the spring 30 is restrained, and the restoring force (extension force) of the spring 30 is adjusted. The restoring force of the spring 30 causes a seat portion 22 of the valve body 20 and the nozzle tip 17 to be seated, whereby the fuel injection holes (described later) of the nozzle tip 17 are closed. Then, when a current supplied from a drive circuit (not illustrated) flows through the solenoid 40, the core 12 is excited to generate a magnetic attraction force, and attracts the anchor 14 against the restoring force of the spring 30. As the anchor 14 moves, the valve body 20 moves while being guided by the guides 15 and 16, and moves away from the nozzle tip 17. Thereby, a plurality of fuel injection holes (not illustrated) of the nozzle tip 17 are simultaneously opened, and the fuel pressurized by the high-pressure fuel pump is ejected from the fuel injection holes.

### Fuel Injection Hole

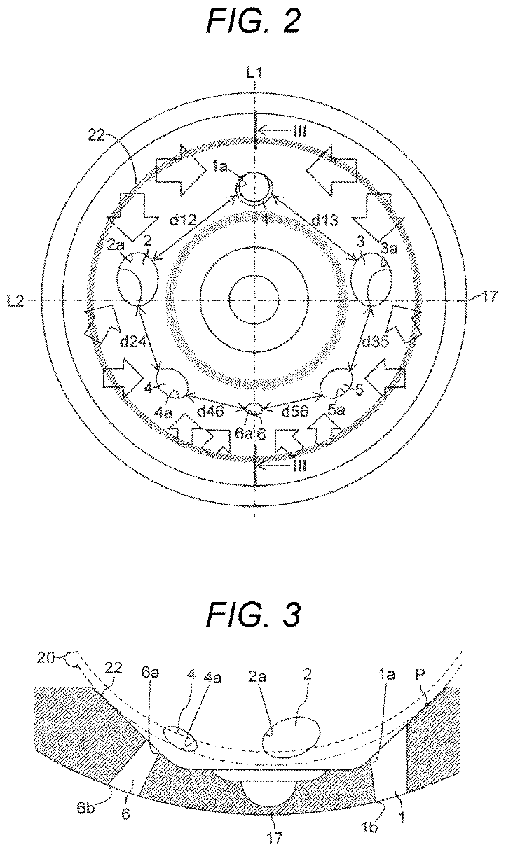

FIG. 2 is a view of a main part of an example of a nozzle tip provided in the fuel injection valve of FIG. 1 viewed from a valve body side, and FIG. 3 is a cross-sectional view taken along line III-III in FIG. 2. As illustrated in FIGS. 2 and 3, the nozzle tip 17 forming the body 10 is provided with a plurality (six in this example) of fuel injection holes 1 to 6. The above-described seat portion 22 is provided at a portion where the valve body 20 and the nozzle tip 17 forming the body 10 face each other. The seat portion 22 is formed in an annular shape so as to collectively surround respective inlets 1a to 6a of all the fuel injection holes 1 to 6 provided in the nozzle tip 17 when viewed from the core 12 side (FIG. 2). As described above, the seat portion 22 of the valve body 20 is separated from or seated on the seat portion 22 of the nozzle tip 17, so that a plurality of fuel injection holes are simultaneously opened and closed. In FIG. 3, the valve body 20 when the valve is closed is indicated by a two-dot chain line, and the valve body 20 when the valve is open is indicated by a broken line.

At this time, the flow path cross-sectional area of the annular gap flow path formed between the seat portions 22 of the valve body 20 and the nozzle tip 17 when the valve is opened is S1. The flow path cross-sectional area S1 is, for example, a flow path cross-sectional area at a position P (FIG. 3) where the distance between the seat portions 22 of the valve body 20 and of the nozzle tip 17 is shortest in an area upstream of the fuel injection holes 1 to 6. Assuming that the sum of the areas of the inlets 1a to 6a of the fuel injection holes 1 to 6 is S2, in this embodiment, a relation of S1>S2 is established between the cross-sectional area S1 of the annular gap flow path and the sum S2 of the areas of the inlets of the fuel injection holes.

The fuel injection holes 1 to 6 are through holes whose orthogonal cross section is circular and the hole center line is straight, but the cross-sectional shape can be changed as long as the size relation between the inlet area and the outlet area can be adjusted. The hole center line may be changed to a bent or curved shape. Further, in this embodiment, the case where six fuel injection holes 1 to 6 are provided is taken as an example, but the number of fuel injection holes can be changed. However, at least three fuel injection holes are required.

In this embodiment, the fuel injection holes 1 to 6 are configured to have different penetrations. In this embodiment, the fuel injection hole 1 forms a high-pressure fuel injection hole having a higher fuel injection pressure than the other fuel injection holes 2 to 6, and the penetration is performed such that the sprayed fuel of the fuel injection hole 1 is the longest. The fuel injection holes 2 to 6 except for the fuel injection hole 1 form low-pressure fuel injection holes having a lower fuel injection pressure than the fuel injection hole 1. The outlets of these fuel injection holes 1 to 6 are oriented in different directions, and in this embodiment, adjacent fuel injection holes are separated from each other as the center lines extending from the outlet in the fuel injection direction become farther while being away from the nozzle tip 17.

The fuel injection holes 1 to 6 are disposed in an annular shape, and the fuel injection hole 1, the fuel injection holes 3, the fuel injection hole 5, the fuel injection hole 6, the fuel injection hole 4, and the fuel injection hole 2 are sequentially arranged in this order in a right-hand turn (clockwise) from the fuel injection hole 1 positioned on the uppermost side in FIG. 2. The annular array formed by the fuel injection holes 1 to 6 may be circular, but need not necessarily be circular. In this embodiment, the centers of the inlets 1a and 6a and the outlets 1b and 6b of the fuel injection holes 1 and 6 are located on the same straight line L1 (FIG. 2) passing through the center of the nozzle tip 17 when viewed from the valve body 20 side. The fuel injection holes 1 to 6 have a layout symmetrical with respect to the straight line L, and the fuel injection holes 2 and 4 are located on the opposite sides of the fuel injection holes 3 and 5 with the straight line L1 interposed between them. The centers of the inlets 1a to 3a (and outlets) of the fuel injection holes 1 to 3 are located on the opposite sides of the centers of the inlets 4a to 6a (and outlet) of the fuel injection holes 4 to 6 with the straight line L2 interposed between them. The straight line L2 is a line orthogonal to the straight line L1 at the center of the nozzle tip 17. In this embodiment, the case where a single annular array is formed by the fuel injection holes 1 to 6 has been described as an example, but a configuration in which a plurality of annular arrays, for example the innermost first annular array, the second annular array covering the outer periphery thereof, and so on, are provided according to the number of fuel injection holes may be employed.

In this embodiment, the fuel injection hole 1, which is a high-pressure fuel injection hole, is a hole on the assumption that the sprayed fuel passes closest to the tip of the ignition plug with the fuel injection valve 100 installed in the internal combustion engine (FIG. 5). Therefore, the center line of the fuel injection hole 1 is formed so as to pass closer to the tip of the ignition plug than any center line of the fuel injection holes 2 to 6, which are low-pressure fuel injection holes. Further, the fuel injection hole 6 farthest from the fuel injection hole 1 is formed so as to direct the piston when the fuel injection valve 100 is installed in the internal combustion engine (FIG. 5).

Further, in this embodiment, a case where only a single fuel injection hole 1 is used as a high-pressure fuel injection hole is illustrated, but a plurality of high-pressure fuel injection holes may be provided. However, in such a case, the high-pressure fuel injection holes are solidified and arranged, and the high-pressure fuel injection holes are adjacent to each other. No low-pressure fuel injection hole is interposed between the two high-pressure fuel injection holes.

Layout of Fuel Injection Hole

Here, the distance (shortest distance) between the inlet of each fuel injection hole and the adjacent hole is defined as follows.
Inter-inlet distance d12: a distance between the inlets 1a and 2a of the fuel injection holes 1 and 2
Inter-inlet distance d13: a distance between the inlets 1a and 3a of the fuel injection holes 1 and 3
Inter-inlet distance d24: a distance between the inlets 2a and 4a of the fuel injection holes 2 and 4
Inter-inlet distance d35: a distance between the inlets 3a and 5a of the fuel injection holes 3 and 5
Inter-inlet distance d46: a distance between the inlets 4a and 6a of the fuel injection holes 4 and 6
Inter-inlet distance d56: a distance between the inlets 5a and 6a of the fuel injection holes 5 and 6
   However, in this embodiment, the distance between each fuel injection hole and the circumferentially adjacent fuel injection hole (the shorter value when the distance to one of the two adjacent holes is different from the distance to the other) is shorter than the distance to any of the other fuel injection holes. In this embodiment, the term “adjacent” uniquely indicates that the holes are adjacent in the circumferential direction of the annular array.

In this embodiment, among the inter-inlet distances d12, d13, d24, d35, d46, and d56, the inter-inlet distance d12 or d13 between the fuel injection hole 1 that is a high-pressure fuel injection hole and the fuel injection hole 2 or 3 that is a low-pressure fuel injection hole adjacent thereto is configured to be widest. In this embodiment, the inter-inlet distances d12 and d13 are equal and the longest, but when making a difference between the d12 and d13, the longer value is the longest, and the shorter value is the second largest value. The inter-inlet distances d24 and d46 may be equal, but it is desirable that the inter-inlet distance d24 is wider than the inter-inlet distance d46. Similarly, the inter-inlet distances d35 and d56 may be the same value, but it is desirable that the inter-inlet distance d35 be wider than the inter-inlet distance d56.

The above conditions are represented by the following inequalities.

d12, d13>d24, d46, d35, d56 (q1)

d12>d24>d46 (q2)

d13>d35>d56 (q3)

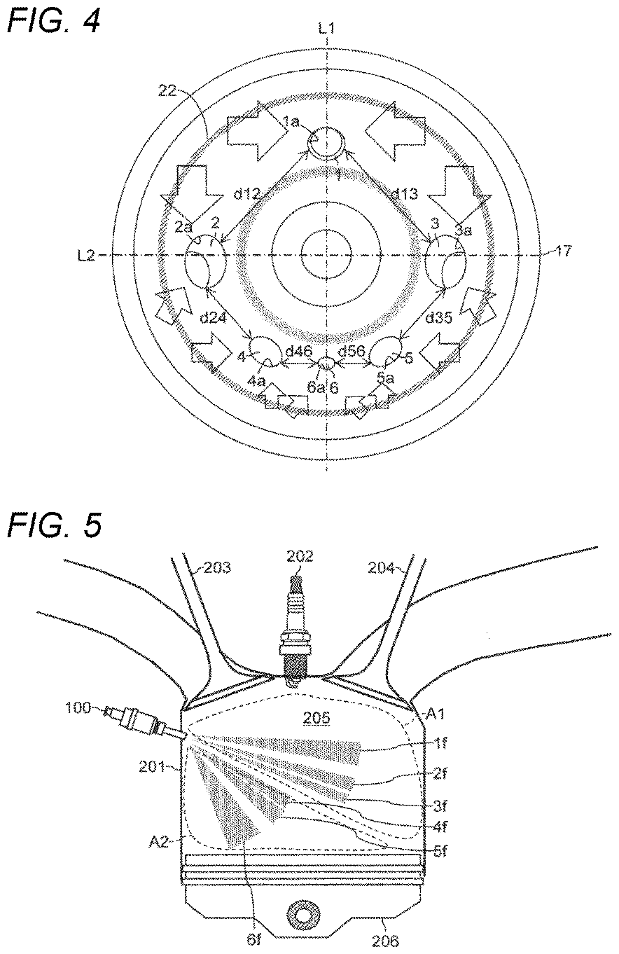

As long as these conditions are satisfied, the layout of the fuel injection holes 1 to 6 can be appropriately adjusted according to the shape of the combustion chamber of the internal combustion engine to which the fuel injection valve is attached. The example illustrated in FIG. 4 has a configuration in which the positions of the fuel injection holes 2, 3 are closer to the fuel injection holes 4 and 5, and the inter-inlet distances d12 and d13 are further enlarged. In the example illustrated in the drawing, the inter-inlet distances d46 and d56 are narrower. In this case, it is considered that the internal pressure of the fuel injection hole 1 is further increased and the penetration is further extended, and the internal pressure of the fuel injection hole is further reduced, so that the penetration is further shortened.

When a plurality of high-pressure fuel injection holes are provided as described above, these are solidified and arranged.

The inter-inlet distance between the high-pressure fuel injection holes is a short distance, and may be shorter than, for example, any other inter-inlet distance. In the case of a configuration in which a plurality of high-pressure fuel injection holes are provided, it is intended that the plurality of fuel injection holes are substituted for one high-pressure fuel injection hole.

Diameter of Fuel Injection Hole

In this embodiment, the fuel injection hole 1, which is a high-pressure fuel injection hole, is formed in a tapered shape such that the flow path cross-sectional area (inner diameter) continuously decreases from the inlet 1a to the outlet 1b. Also, similarly to the fuel injection hole 1, the fuel injection holes 2 and 3 among the low-pressure fuel injection holes are also formed in a tapered shape in which the flow path cross-sectional area continuously decreases from the inlets 2a and 3a to the outlet (not illustrated). In this embodiment, the fuel injection hole 1 and the fuel injection holes 2 and 3 have similar shapes, but these need not necessarily be similar shapes.

On the other hand, the fuel injection hole 6, which is a low-pressure fuel injection hole located farthest from the fuel injection hole 1, is formed in a tapered shape in which the flow path cross-sectional area (inner diameter) continuously increases from the inlet 6a to the outlet 6b. In particular, in this embodiment, among the low-pressure fuel injection holes, the low-pressure fuel injection holes other than the fuel injection holes 2 and 3 adjacent to the fuel injection hole 1 are formed in a tapered shape in which the flow path cross-sectional area continuously increases from the inlet to the outlet. That is, not only the fuel injection hole 6 but also the fuel injection holes 4 and 5 adjacent thereto have the expanding flow path cross-sectional area continuously from the inlets 4a and 5a to the outlet (not illustrated) similarly to the fuel injection hole 6. In this embodiment, the fuel injection hole 6 and the fuel injection holes 4 and 5 have similar shapes, but they need not necessarily have similar shapes.

Effects

(1) When the valve body 20 is pulled up and fuel flows into the fuel injection holes 1 to 6, the fuel that is pumped at a high pressure flows into the nearest fuel injection holes. That is, the fuel injection holes 1 to 6 share fuel with the adjacent fuel injection holes. Therefore, fuel flows into a fuel injection hole of adjacent fuel injection holes only from a narrow area around the fuel injection hole when an inter-inlet distance between the adjacent fuel injection holes is short. On the other hand, fuel flows into a fuel injection hole of adjacent fuel injection holes from a wide area around the fuel injection hole when an inter-inlet distance between the adjacent fuel injection holes is long, so that the fuel flow rate increases accordingly.

Based on this finding, the inventors of the present application have determined to lay out the fuel injection holes 1 to 6 such that the distances d12 and d13 between the inlets of the fuel injection hole 1 and the adjacent hole assuming the longest penetration is longer than the other inter-inlet distances d24, d46, d35, and d56. According to this configuration, as indicated by the size of the arrow in FIG. 2, the fuel flow rate concentrated in the fuel injection hole 1 becomes larger than the fuel flow rate flowing into the other fuel injection holes 2 to 6. If the conditions such as the opening area and the hole shape are the same, the pressure in the hole can be the highest in the fuel injection hole 1 among the fuel injection holes 1 to 6, and penetration can be lengthened by increasing the fuel injection speed of the fuel injection hole 1 compared with the other fuel injection holes 2 to 6.

According to this embodiment, the length of the penetration of the sprayed fuel can be adjusted for each hole by making the pressure in each hole different depending on the inter-inlet distances between the fuel injection holes 1 to 6. For example, in a case where a distance between a fuel injection hole and the structure in the combustion chamber is long, the structure interfering with the sprayed fuel when the fuel injection hole 100 is mounted on an internal combustion engine, an inter-inlet distance between the fuel injection hole and the adjacent hole is set to be long like the fuel injection hole 1. On the contrary, in a case a distance between a fuel injection hole and the structure that interferes with the sprayed fuel is short, an inter-inlet distance between the fuel injection hole and the adjacent hole is set to be short like the fuel injection hole 6. Because of this configuration, it is possible to improve the dispersibility of the fuel in the combustion chamber while suppressing the adhesion of the fuel to the structure in the combustion chamber of the internal combustion engine. Therefore, the combustion state of the fuel in the combustion chamber of the internal combustion engine can be improved, and the fuel efficiency can be improved and incomplete combustion can be suppressed.

(2) The injection pressure can also be increased by reducing the flow path cross-sectional area of the fuel injection hole toward the outlet and narrowing the flow path. In this embodiment, since the inner diameter of the fuel injection hole 1, which is a high-pressure fuel injection hole, is reduced from the inlet la to the outlet lb, the pressure in the fuel injection hole 1 can also be increased with the change in the hole diameter. Thus, in combination with the above Effect 1, the pressure in the fuel injection hole 1 can be increased to increase the fuel emission speed to the maximum, and effectively contributes to the extension of the penetration of the sprayed fuel in the fuel injection hole 1.

Further, in this embodiment, the penetration is set longer as the fuel injection hole is displayed on the upper side in FIG. 2, and the penetration is set shorter as the fuel injection hole is displayed on the lower side. Since the inner diameters of the fuel injection holes 2 and 3 adjacent to the fuel injection hole 1 are also decreased toward the outlet, the pressure in the holes can be easily increased as compared with the fuel injection holes 4 to 6.

However, even if the fuel injection hole 1 does not have such a throttle shape, the penetration can be extended by setting the inter-inlet distances d12 and d13, so that the fuel injection hole 1 does not necessarily need to have the throttle shape (see FIG. 10). The same applies to the fuel injection holes 2 and 3.

(3) On the contrary, the injection pressure can be lowered by increasing the flow path cross-sectional area of the fuel injection hole toward the outlet. In this embodiment, since the inner diameter of the fuel injection hole 6 farthest from the fuel injection hole 1 is enlarged from the inlet 6a toward the outlet 6b, it is possible to reduce the pressure in the fuel injection hole 1 also by this change in the hole diameter. Thus, in combination with the effect 1, the pressure in the fuel injection hole 6 can be reduced to minimize the fuel emission speed, which effectively contributes to shortening the penetration of the sprayed fuel in the fuel injection hole 6. Further, since the inner diameters of the fuel injection holes 4 and 5 adjacent to the fuel injection holes 6 are also increased toward the outlet, the pressure in the holes can be easily reduced as compared with the fuel injection holes 1 to 3. Further, since the diameters of the fuel injection holes 4 to 6 are increased toward the outlet, the spray is easy to spread, which also contributes to the suppression of penetration and has preferable fuel diffusivity.

However, even if the fuel injection hole 6 does not have such an expanded shape, the penetration can be shortened by setting the inter-inlet distances d46 and d56, so that the fuel injection hole 6 does not necessarily need to have the expanded shape (see FIG. 10). The same applies to the fuel injection holes 4 and 5.

(4) The fuel flowing into the fuel injection holes 1 to 6 passes through an annular gap flow path formed between the nozzle tip 17 and the valve body 20 when the valve is opened. Accordingly, if the flow path cross-sectional area S1 of the gap flow path that passes before the fuel flows into the fuel injection holes 1 to 6 are smaller than the sum S2 of the total opening area of the inlets 1a to 6a of the fuel injection holes 1 to 6, the fuel pressure is reduced before flowing into the fuel injection holes 1 to 6. Therefore, in this embodiment, the configuration is such that the relation of S1>S2 is established. Thereby, the pressure loss of the fuel before flowing into the fuel injection holes 1 to 6 can be reduced, and the above-mentioned Effects 1 to 3 can be more effectively exerted.

First Application

FIG. 5 is a schematic diagram illustrating an example of application of the fuel injection valve of FIG. 1 to an internal combustion engine. In the example of the drawing, the fuel injection valve 100 is mounted on the side (outer circumference) of a cylinder 201 of the internal combustion engine with the fuel injection holes 1 and 6 up and down. An ignition plug 202 of the internal combustion engine is installed at a position above the cylinder 201 and between an intake valve 203 and an exhaust valve 204. The fuel injection valve 100 is installed in a posture inclined downward toward a combustion chamber 205 formed inside the cylinder 201, and a sprayed fuel if of the fuel injection hole 1 passes through the upper part of the combustion chamber 205, and passes through the vicinity of the ignition plug 202 most in the sprayed fuel. The sprayed fuels 2f to 5f in the fuel injection holes 2 to 5 are diffused and injected in a middle direction between the upper and lower sides of the combustion chamber 205. In the illustration of FIG. 5, the sprayed fuels 2f and 3f can be geometrically overlapped, but are shifted in the drawing for convenience. The same applies to the sprayed fuels 4f and 5f. The sprayed fuel 6f of the fuel injection hole 6 is injected downward with respect to the center of the combustion chamber 205, and is directed to a piston 206. This example is an example, but since the shape of the combustion chamber differs depending on the internal combustion engine, the setting of the fuel direction of each fuel injection is appropriately adjusted in accordance with the shape of the combustion chamber at the stage of manufacturing the nozzle tip. The inlet area and outlet area of each fuel injection hole are also appropriately adjusted according to the intended injection direction and distribution of the spray flow rate.

Next, the behaviors of the sprayed fuels if to 6f of the fuel injection valve 100 in this application will be described. Here, the combustion chamber 205 is virtually divided into a region A1 and a region A2. When the combustion chamber 205 is divided into two parts, an upper part and a lower part, by a plane including the straight line L2 and the center line of the valve body 20 in FIG. 2, the space on the ignition plug 202 side is the region A1, and the space on the piston 206 side is the region A2. In this example, the fuel injection valve 100 is disposed obliquely on the upper part side of the cylinder 201, and the plane that separates the regions A1 and A2 descends from the fuel injection valve 100 in the fuel injection direction as illustrated in FIG. 5. The region A1 has a long distance from the fuel injection valve 100 to a structure such as a wall facing the piston 206 and the combustion chamber 205, and has a greater depth than the region A2 with respect to the fuel injection valve 100. In the region A2, the distance from the fuel injection valve 100 to a structure such as the piston 206 is short, and the depth is smaller than the region A1 with respect to the fuel injection valve 100.

The sprayed fuels 1f to 3f are injected into the region A1 from the fuel injection holes 1 to 3. The sprayed fuels 1f to 3f as a whole have a high injection pressure, and especially the sprayed fuel 1f injected from the fuel injection hole 1 has a long penetration. By injecting the sprayed fuels 1f to 3f having a relatively long penetration into the region A1 having a large depth in this manner, the fuel can be spread over the region A1 and the mixing of the fuel can be promoted. Since the region A1 has a large depth, even if the penetration of the sprayed fuels 1f to 3f is extended in this manner, the adhesion of the fuel to the structure facing the combustion chamber 205 can be suppressed.

On the other hand, in the region A2, the sprayed fuels 4f to 6f are injected from the fuel injection holes 4 to 6. The sprayed fuels 4f to 6f have a low injection pressure as a whole, and especially the sprayed fuel 6f injected from the fuel injection holes 6 has a short penetration. The sprayed fuels 4f to 6f easily spread the spray diameter and are suitable for diffusing the fuel into the region A2 having a small depth. By injecting the sprayed fuels 4f to 6f having a relatively short penetration into the region A2 having a small depth in this manner, the adhesion of the fuel to the structure facing the combustion chamber 205 can be suppressed. Further, even in the narrow region A2, since the fuel can be injected with a short penetration, the fuel distribution in the region A2 can be made uniform.

As described above, by changing the fuel spray characteristics for each region such as the regions A1 and A2, it is possible to achieve both the effect of promoting the mixing of the fuel and the air and the effect of reducing the adhesion of the fuel to the structure.

Second Application

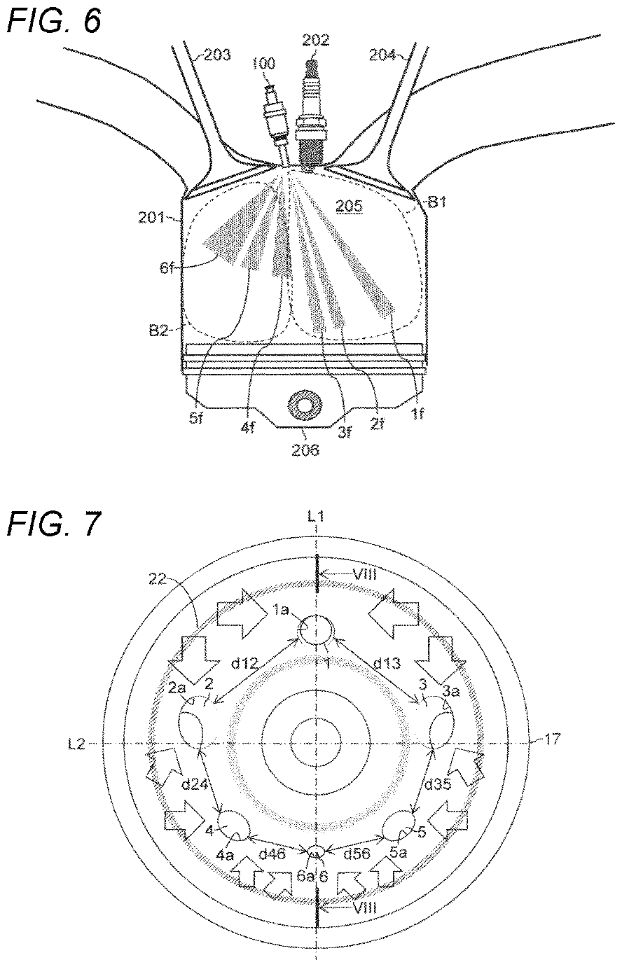

FIG. 6 is a schematic diagram illustrating another application of the fuel injection valve of FIG. 1 to an internal combustion engine. Elements in FIG. 6 that are the same as or correspond to those in the first application are given the same reference numerals as in FIG. 5, and descriptions thereof are omitted. This embodiment is an example in which the fuel injection valve 100 is mounted above the cylinder 201 between the intake valve 203 and the exhaust valve 204 together with the ignition plug 202. In order to provide the fuel injection valve 100, the ignition plug 202 is offset from the center position of the upper part of the cylinder 201 toward the exhaust valve 204, and the fuel injection valve 100 is offset from the center position of the upper part of the cylinder 201 toward the intake valve 203. The fuel injection valve 100 is inclined downward toward the exhaust valve 204 by the amount offset toward the intake valve 203, and is installed in the internal combustion engine in a posture that the fuel is injected in a direction along the airflow drawn from the intake valve 203 to the combustion chamber 205.

In this example, the combustion chamber 205 is virtually divided into two parts, a left part and a right part, on a plane including the straight line L2 and the center line of the valve body 20 in FIG. 4, and the space on the exhaust valve 204 side becomes a region B1, and the space on the intake valve 203 side becomes a region B2. The sprayed fuels if to 3f injected from the fuel injection holes 1 to 3 are injected into the region B1 and crosses below the ignition plug 202. Since the fuel injection valve 100 is in the inclined posture, the depth of the combustion chamber 205 with respect to the fuel injection valve 100 is wider in the region B1 than in the region B2. Therefore, it is appropriate to inject the sprayed fuels 1f to 3f having a long penetration into the region B1. Further, the sprayed fuels 4f to 6f injected from the fuel injection holes 4 to 6 are injected into the region B2 toward the piston 206. For the region B2 having a small depth when viewed from the fuel injection valve 100, the sprayed fuels 4f to 6f having a spray shape in which the penetration is short and wide is suitable. In particular, when the fuel injection valve 100 is mounted on the upper part of the cylinder 201, mixing of fuel and air can be promoted by injecting the fuel along the airflow sucked from the intake valve 203 as in this example.

### Second Embodiment

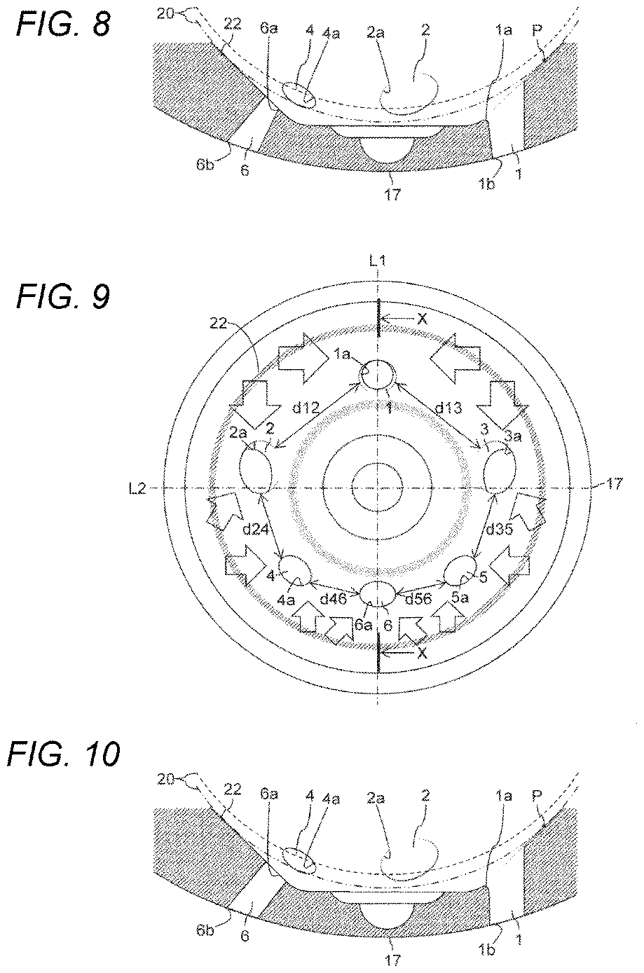

FIG. 7 is a diagram of a main part of a nozzle tip provided in a fuel injection valve according to a second embodiment of the invention viewed from a valve body side, and FIG. 8 is a cross-sectional view taken along line VIII-VIII in FIG. 7. FIGS. 7 and 8 are diagrams corresponding to FIGS. 2 and 3 of the first embodiment. In this embodiment, the same or corresponding elements as those in the first embodiment are denoted by the same reference numerals as those in the previous drawings, and description thereof is omitted.

This embodiment is different from the first embodiment in that the corner of the inlet la in a cross section cut along a plane including the center line of the fuel injection hole 1 (the corner that forms a boundary between the surface of the nozzle tip 17 facing the valve body 20 and the inner wall surface of the fuel injection hole 1) is smoothed into an R shape without edges. The size of R is determined by the flow rate of fuel flowing into the fuel injection hole 1 and the angle of the fuel injection hole 1. In this embodiment, in addition to the fuel injection hole 1, the edges of the inlets 2a and 3a of the fuel injection holes 2 and 3 in which the penetration of the sprayed fuel is long are similarly formed in an R shape. The inlets 4a to 6a of the fuel injection holes 4 to 6 are not provided with R, but may be configured to have R smaller than R of the inlets 1a to 3a of the fuel injection holes 1 to 3, for example. The other points are the same as those of the first embodiment, including the shape and size relation of the components of the fuel injection valve, the layout, the installation mode in the internal combustion engine, and the illustrated configuration as an example.

According to this embodiment, since the configuration is the same as that of the first embodiment except for the above difference, the above-described Effects 1 to 4 can be obtained similarly to the first embodiment. In addition, in this embodiment, the inlets la to 3a of the fuel injection holes 1 to 3 are provided with R to make the turning angle of the fuel flow before and after flowing into the fuel injection holes 1 to 3 gentle, so that the separation of fuel flow can be suppressed when flowing into the fuel injection holes 1 to 3. This suppresses a decrease in the pressure in the fuel injection holes 1 to 3, and makes it easier to ensure a long penetration of the sprayed fuel injected from the fuel injection holes 1 to 3. Therefore, it is more advantageous than the first embodiment when an internal combustion engine having a wider combustion chamber or an internal combustion engine having a stronger airflow in the combustion chamber is to be installed with the fuel injection valve.

The purpose of adding an R to the inlet is to increase the pressure in the hole. For example, depending on the internal combustion engine in which the fuel nozzle is installed, the fuel injection holes 4 to 6 may also be an object to which the R is provided at the inlet. At least one of the fuel injection holes 1 to 6 has an R-shape, and the taper of the hole inner wall and the R of the inlet are appropriately combined to adjust the pressure in the hole corresponding to the inter-inlet distance.

### Third Embodiment

FIG. 9 is a diagram of a main part of a nozzle tip provided in a fuel injection valve according to a third embodiment of the invention viewed from a valve body side, and FIG. 10 is a cross-sectional view taken along line X-X in FIG. 9. FIGS. 9 and 10 are diagrams corresponding to FIGS. 2 and 3 of the first embodiment. In this embodiment, the same or corresponding elements as those in the first or second embodiment are denoted by the same reference numerals as those in the previous drawings, and description thereof is omitted.

This embodiment is different from the first embodiment in that the fuel injection holes 1 to 6 are formed in a cylindrical shape (straight pipe hole) having a constant flow path cross-sectional area from the inlet to the outlet. The flow path cross-sectional area of each hole is determined in consideration of the inter-inlet distance and the distribution of the flow rate of the fuel to flow. In this embodiment, the case where all the fuel injection holes 1 to 6 are formed in a cylindrical shape with no change in the cross-sectional area is exemplified. However, at least one of the fuel injection holes 1 to 6 may be formed in a cylindrical shape. In this b embodiment, as in the second embodiment, the inlets 1a to 3a of the fuel injection holes 1 to 3 are provided with R, but this is not always necessary. The other points are the same as those of the first or second embodiment, including the shape and size relation of the components of the fuel injection valve, the layout, the installation mode in the internal combustion engine, and the illustrated configuration as an example.

According to this embodiment, the same effects (excluding the Effects 2 and 3) as in the first or second embodiment can be obtained. In addition, in this embodiment, the penetration of the sprayed fuel in the fuel injection holes 1 to 3 can be shorter than in the first and second embodiments corresponding to elimination of the throttle effect. On the contrary, the penetration of the sprayed fuel in the fuel injection holes 4 to 6 can be long. By utilizing such a change in penetration, the penetration can be flexibly adjusted according to the size and shape of the combustion chamber of the internal combustion engine. In addition, since the fuel injection holes are cylindrical, there is an advantage that the ease of manufacture is improved.

### Fourth Embodiment

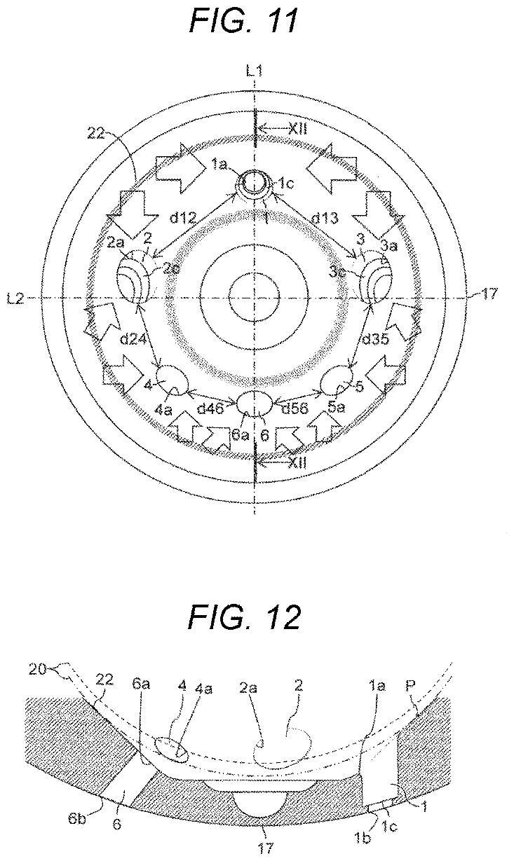

FIG. 11 is a diagram of a main part of a nozzle tip provided in a fuel injection valve according to a fourth embodiment of the invention viewed from a valve body side, and FIG. 12 is a cross-sectional view taken along line XII-XII in FIG. 11. FIGS. 11 and 12 are diagrams corresponding to FIGS. 2 and 3 of the first embodiment. In this embodiment, the same or corresponding elements as those in any of the first to third embodiments are denoted by the same reference numerals as those in the previous drawings, and description thereof is omitted.

This embodiment is different from the first embodiment in that the fuel injection holes are provided with stepped throttle portions 1c to 3c. In the first embodiment, the inner diameters of the fuel injection holes 1 to 3 are tapered from the inlet to the outlet, whereas in this embodiment, the inner diameters of the fuel injection holes 1 to 3 are formed as a step. The throttle portions 1c to 3c discretely reduce the size, and the outlet is smaller than the inlet. The inlet area and the outlet area of the fuel injection holes 1 to 3 are determined in consideration of the inter-inlet distance of each hole and the distribution of the fuel flow rate to flow into each hole. In this embodiment, the case where the stepped throttle portion is provided in the fuel injection holes 1 to 3 is exemplified, but the hole provided with the stepped throttle portion can be appropriately changed according to the distribution of the fuel flow rate to flow into each hole and the like.

In this embodiment, the case where the fuel injection holes 4 to 6 are formed in a cylindrical shape is exemplified, but a stepped throttle may be provided in the fuel injection holes 4 to 6 in some cases. Further, a tapered throttle and a stepped throttle may be selectively applied to each hole, or a combination of the tapered throttle and the stepped throttle may be applied to the same fuel injection hole. Although not illustrated, when the outlet is increased with respect to the inlet of the fuel injection hole, the fuel injection hole is not formed in a tapered shape as in the fuel injection holes 4 to 6 of the first embodiment, but may be enlarged in a step shape. In addition, in this embodiment, as in the second embodiment, R is added to the inlets 1a to 3a of the fuel injection holes 1 to 3, but this is not always necessary. The other points are the same as any one of the three embodiments described above, including the shape and size relation of the components of the fuel injection valve, the layout, the installation mode in the internal combustion engine, and the illustrated configuration as an example.

Even in the case of a stepped throttle as in this embodiment, the same effect as that of the tapered throttle can be obtained, and the same effect as that described in the previous embodiment can be obtained.

### REFERENCE SIGNS LIST

1 fuel injection hole (high-pressure fuel injection hole)

2, 3 fuel injection hole (low-pressure fuel injection hole adjacent to high-pressure fuel injection hole)

4, 5 fuel injection hole (low-pressure fuel injection hole except those adjacent to high-pressure fuel injection hole)

6 fuel injection hole (low-pressure fuel injection hole located farthest from high-pressure fuel injection hole)

1a-6a inlet

1b-6b outlet

1c-3c stepped throttle portion

10 body

20 valve body

22 seat portion

100 fuel injection valve

201 cylinder

202 ignition plug

203 intake valve

204 exhaust valve

206 piston

d12, d13, d24, d35, d46, d56 inter-inlet distance

1. A fuel injection valve, comprising:
a body that has a plurality of fuel injection holes; and
a valve body that is formed in an annular shape with a seat portion seated on the body surrounding the plurality of fuel injection holes,
wherein the plurality of fuel injection holes, each having a different penetration, includes at least one high-pressure fuel injection hole having a longest penetration and a plurality of low-pressure fuel injection holes except the high-pressure fuel injection hole, and
wherein an inter-inlet distance of the high-pressure fuel injection hole and a low-pressure fuel injection hole adjacent to the high-pressure fuel injection hole is widest among inter-inlet distances between the inlets of adjacent fuel injection holes.

2. The fuel injection valve according to claim 1, wherein a cross-sectional area of a gap flow path opened and closed by the valve body is larger than a sum of inlet areas of the plurality of fuel injection holes.

3. The fuel injection valve according to claim 1, wherein the high-pressure fuel injection hole is formed in a tapered shape in which a flow path cross-sectional area decreases from an inlet to an outlet, or formed in a cylindrical shape having the same cross-sectional area from an inlet to an outlet.

4. The fuel injection valve according to claim 1, wherein a low-pressure fuel injection hole located farthest from the high-pressure fuel injection hole is formed in a tapered shape in which a flow path cross-sectional area increases from an inlet to an outlet, or formed in a cylindrical shape with the same cross-sectional area from the inlet to the outlet.

5. The fuel injection valve according to claim 1, wherein the low-pressure fuel injection hole except those adjacent to the high-pressure fuel injection hole is formed in a tapered shape in which a flow path cross-sectional area increases from an inlet to an outlet, or formed in a cylindrical shape with the same cross-sectional area from the inlet to the outlet.

6. The fuel injection valve according to claim 1, wherein an edge of an inlet of the high-pressure fuel injection hole has an R shape.

7. The fuel injection valve according to claim 1, wherein the high-pressure fuel injection hole has a stepped throttle portion.

8. The fuel injection valve according to claim 1, wherein, when the fuel injection valve is installed in the internal combustion engine, a center line of the high-pressure fuel injection hole passes closer to a tip of an ignition plug than a center line of any low-pressure fuel injection hole.

9. The fuel injection valve according to claim 1, wherein, when the fuel injection valve is installed in the internal combustion engine, a fuel injection hole that is located farthest from the high-pressure fuel injection hole is directed toward a piston.

10. The fuel injection valve according to claim 1, wherein the fuel injection valve is disposed on an outer peripheral portion of a cylinder of the internal combustion engine in a posture inclined downward toward a combustion chamber, and a sprayed fuel of the high-pressure fuel injection hole passes closest to an ignition plug.

11. The fuel injection valve according to claim 1, wherein the fuel injection valve is located at an upper portion of a cylinder of the internal combustion engine so as to be positioned between an intake valve and an exhaust valve and to inject fuel along an airflow drawn into a combustion chamber from the intake valve.
